(19) United States
(12) Patent Application Publication
(10) Pub. No.: US 2025/0281997 A1
(43) Pub. Date: Sep. 11, 2025

(54) FRICTION STIR WELDING APPARATUS AND FRICTION STIR WELDING METHOD

(71) Applicant: HONDA MOTOR CO., LTD., Tokyo (JP)

(72) Inventors: Akiyoshi MIYAWAKI, Wako-shi (JP); Ryuzo SAKAMOTO, Wako-shi (JP); Yuto IKE, Wako-shi (JP); Yuto HARASHIMA, Wako-shi (JP)

(21) Appl. No.: 19/059,756

(22) Filed: Feb. 21, 2025

(30) Foreign Application Priority Data
Mar. 7, 2024 (JP) 2024-034655

(51) Int. Cl. B23K 20/12

(52) U.S. Cl. CPC B23K 20/1255

(57) ABSTRACT

A friction stir welding apparatus includes an anvil, a probe, and a shoulder member. The probe includes: a joining probe which advances toward plate members of a stacked body, forms a joint hole in the plate members softened by frictional heat generated by a joining surface of the joining probe coming into sliding contact with the plate members and joins the plate members, and forms an overlay portion protruding in a bank shape from a plate surface around the joint hole along an inner peripheral surface of the shoulder member; and a backfilling probe which advances toward the plate members, and backfills the joint hole with the overlay portion softened by frictional heat generated by a backfilling surface of the backfilling probe coming into sliding contact with the overlay portion. The joining probe and the backfilling probe are disposed to be replaceable with each other.

### CROSS-REFERENCE TO RELATED APPLICATION

This application claims the benefit of foreign priority to Japanese Patent Application No. 2024-034655, filed on Mar. 7, 2024, which is incorporated by reference in its entirety.

### BACKGROUND OF THE INVENTION

### 1. Field of the Invention

The present invention relates to a friction stir welding apparatus and a friction stir welding method for joining stacked plate members using friction stirring.

### 2. Description of the Related Art

In recent years, there have been strong demands for reduction in adverse influence on the environment (SDGs 11.6) and improvement in energy efficiency (SDGs 7.3) regarding the quality of the atmosphere in a production process of products.

In such trends, the approach of joining a plurality of members has been reviewed.

For example, as methods for joining a plurality of metal plate members, welding methods such as arc welding have been widely employed. However, a joining method using friction stirring as proposed in JP2023-013804A has been attracting attention because gas generated during the joining step can be reduced and consumed power can be reduced as compared with the above joining methods.

### SUMMARY OF THE INVENTION

Meanwhile, in the case of joining metals having different properties by using friction stirring, a material adjacent portion having a large potential difference is exposed to the surface at a joined portion.

Hence, in the case where a joining portion comes into contact with water due to condensation or the like, electric corrosion occurs. To prevent such electric corrosion, an anti-corrosion treatment (a chemical conversion treatment, a waterproof sealer application, or the like) is required, causing a problem that steps are complicated.

The present invention has been made in view of the aforementioned points, and an object of the present invention is to provide a friction stir welding apparatus and a friction stir welding method which can suppress the generation of electric corrosion in a joining step without newly providing a step of applying a waterproof sealer to a material adjacent portion.

To achieve the above-described object, a friction stir welding apparatus according to the present invention comprises: an anvil which supports a stacked body including stacked plate members; a probe which is disposed to face the anvil, and is disposed to be capable of advancing and retreating relative to the stacked body and capable of rotating about a rotation axis along an advancing and retreating direction; and a shoulder member which has a cylindrical shape through which the probe is capable of being inserted, and holds the stacked body between the shoulder member and the anvil, wherein the probe includes: a joining probe which advances toward the plate members, forms a joint hole in the plate members softened by frictional heat generated by a joining surface of the joining probe coming into sliding contact with the plate members and joins the plate members, and forms an overlay portion protruding in a bank shape from a plate surface around the joint hole along an inner peripheral surface of the shoulder member; and a backfilling probe which advances toward the plate members, and backfills the joint hole with the overlay portion softened by frictional heat generated by a backfilling surface of the backfilling probe coming into sliding contact with the overlay portion, and the joining probe and the backfilling probe are disposed to be replaceable with each other.

### BRIEF DESCRIPTION OF THE DRAWINGS

The drawings described herein are for illustration purposes only and are not intended to limit the scope of the present invention in any way.

FIG. 1 is a schematic configuration diagram illustrating a friction stir welding apparatus according to one embodiment of the present invention.

FIG. 2 is an enlarged sectional view of a main part, illustrating a state in which a stacked body has been positioned during a joining step by friction stirring.

FIG. 3 is an enlarged sectional view of a main part, illustrating a state in which a joining probe has advanced and is in sliding contact with the stacked body during the joining step by friction stirring.

FIG. 4 is an enlarged sectional view of a main part, illustrating a state in which a joint hole is formed and an overlay portion is formed in the stacked body during the joining step by friction stirring.

FIG. 5 is an enlarged sectional view of a main part, illustrating a state in which plate members have been welded by a resistance welder during the joining step by friction stirring.

FIG. 6 is an enlarged sectional view of a main part, illustrating a state in which the joining probe has retreated in the joining step by friction stirring.

FIG. 7 is an enlarged sectional view of a main part, illustrating a state in which the joining probe has been replaced with a backfilling probe in the joining step by friction stirring.

FIG. 8 is an enlarged sectional view of a main part, illustrating a state in which the backfilling probe has advanced and is in sliding contact with an overlay portion in the joining step by friction stirring.

FIG. 9 is an enlarged sectional view of a main part, illustrating a state in which the joint hole has been backfilled in the joining step by friction stirring.

FIG. 10 is an enlarged sectional view of a main part, illustrating a state in which the backfilling probe has retreated and the joining step has been completed in the joining step by friction stirring.

FIG. 11 is an enlarged sectional view of a main part, illustrating a state in which a backfilling probe of a first modification has advanced and is in sliding contact with an overlay portion in the joining step by friction stirring.

FIG. 12 is an enlarged sectional view of a main part, illustrating a state in which a joint hole has been backfilled by the first modification in the joining step by friction stirring.

FIG. 13 is an enlarged sectional view of a main part, illustrating a state in which a backfilling probe of a second modification has advanced and is in sliding contact with an overlay portion in the joining step by friction stirring.

FIG. 14 is an enlarged sectional view of a main part, illustrating a state in which a joint hole has been backfilled by the second modification in the joining step by friction stirring.

FIG. 15 is a perspective view showing a backfilling probe of a third modification.

FIG. 16 is a plan view showing a backfilling surface in the backfilling probe of the third modification.

FIG. 17 is a sectional view taken along line A-A in FIG. 16.

FIG. 18 is an enlarged sectional view of a main part, illustrating a state in which a joint hole has been backfilled by the third modification in the joining step by friction stirring.

### DETAILED DESCRIPTION

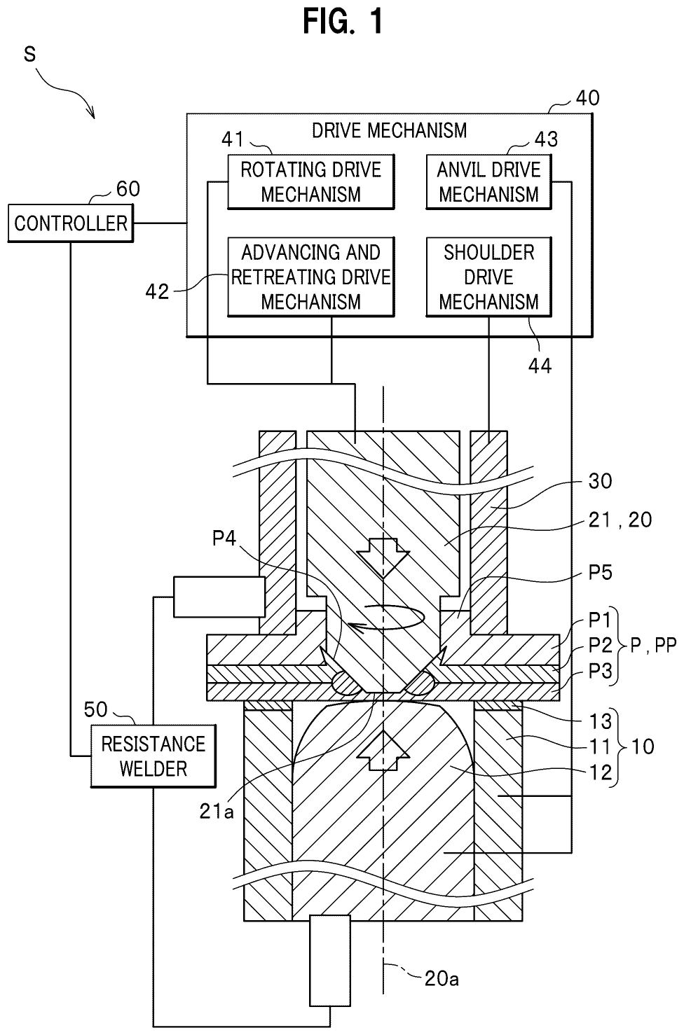

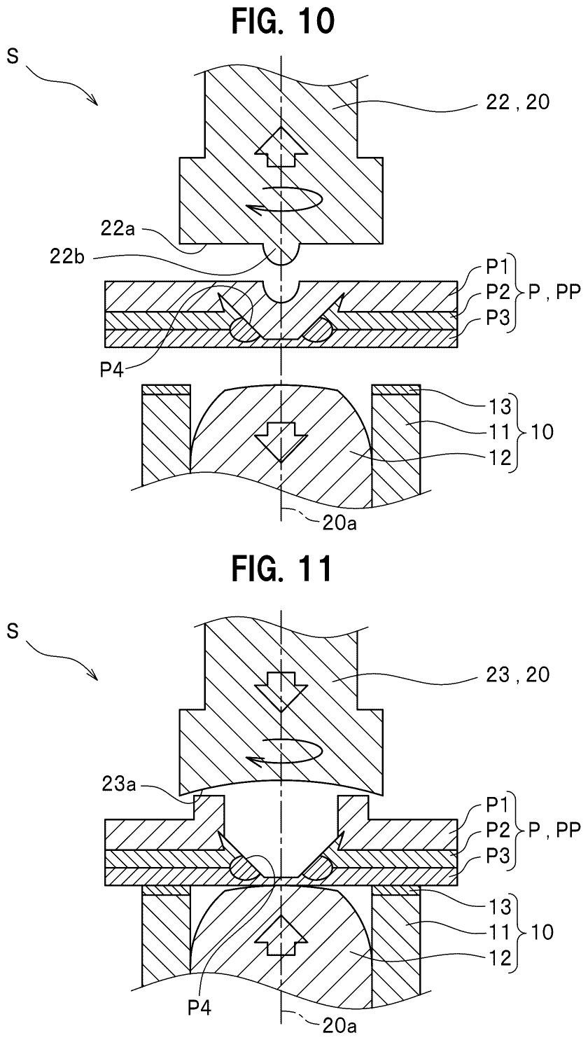

A friction stir welding apparatus S according to one embodiment of the present invention will be described in detail with reference to FIGS. 1 to 10.

Note that in the description, the same elements are denoted by the same reference signs, and repetitive descriptions will be omitted.

The friction stir welding apparatus S of the present embodiment joins plate members P stacked in a plate thickness direction with each other (see FIG. 1).

Then, the stacked plate members P will be referred to as a stacked body PP.

Note that in the friction stir welding apparatus S of the present embodiment, the stacked body PP is disposed such that its plate surfaces face in upper-lower directions.

The stacked body PP is configured with stacked three plate members P made of metals (see FIG. 1).

In the stacked body PP, a plate member P (an upper member P1) that is located at the top is formed of an aluminum alloy.

In addition, in the stacked body PP, a plate member P (a middle member P2) that is located in the middle and a plate member P (a lower member P3) that is located at the bottom are formed of the same iron alloy.

That is, the upper member P1 is formed of a material having a lower melting point than that of the middle member P2 and the lower member P3.

The friction stir welding apparatus S includes an anvil 10, a probe 20, a shoulder member 30, a drive mechanism 40, a resistance welder 50, and a controller 60.

The anvil 10 is disposed to be capable of advancing and retreating relative to the probe 20 (the stacked body PP) along a rotation axis 20a of the probe 20, and is moved by the drive mechanism 40.

Note that the direction along the rotation axis 20a is referred to as an advancing and retreating direction.

The anvil 10 supports the stacked body PP from below in the state of having advanced toward the probe 20.

The anvil 10 includes a receiving portion 11 and a semi-spherical portion 12.

The receiving portion 11 and the semi-spherical portion 12 are formed of separate members.

The receiving portion 11 has a cylindrical shape, and is disposed to be capable of moving along the rotation axis 20a.

The receiving portion 11 includes an insulating material 13 disposed on an upper end surface thereof which comes into contact with the stacked body PP.

The semi-spherical portion 12 is formed with a column-shaped member having a semi-spherical shape protruding upward in an upper end portion thereof, and is disposed inside the cylinder of the receiving portion 11.

The semi-spherical portion 12 is disposed to be capable of moving along the rotation axis 20a together with the receiving portion 11.

The semi-spherical portion 12 is formed of a conductive material.

The anvil 10 is configured such that a front end of the semi-spherical portion 12 comes into contact with the stacked body PP while the receiving portion 11 supports the stacked body PP.

The probe 20 joins and backfills the stacked body PP.

The probe 20 is disposed to be capable of rotating about the rotation axis 20a and capable of advancing and retreating relative to the anvil 10 (the stacked body PP) along the rotation axis 20a.

The probe 20 rotates and moves with the drive mechanism 40 as a drive source.

The probe 20 is formed of a material such as ceramic or cemented carbide.

That is, for the probe 20, a material that is harder and has a higher melting point than the material of the stacked body PP is selected.

The probe 20 includes a joining probe 21 and a first backfilling probe 22 (a backfilling probe).

The probe 20 is configured to be attachable to and detachable from the friction stir welding apparatus S and allow the joining probe 21 and the first backfilling probe 22 to be replaced with each other.

The joining probe 21 joins three plate members P included in the stacked body PP with each other.

The joining probe 21 has a substantially columnar shape and has a tapered front end portion having a tapered shape.

The joining probe 21, while rotating, advances toward the stacked body PP from an upper side to a lower side in FIG. 1 to FIG. 10, and a joining surface 21a formed in the front end thereof comes into sliding contact with the stacked body PP.

The sliding contact generates frictional heat between the front end of the joining probe 21 and the stacked body PP, and the frictional heat softens the stacked body PP in the order of the upper member P1, the middle member P2, and the lower member P3.

Then, as the joining probe 21 further advances, the front end of the joining probe 21 pushes each member of the softened stacked body PP aside, forming a joint hole P4 and joining the members with each other.

In addition, an overlay portion P5 protruding in a bank shape from a plate surface is formed inside an inner peripheral surface of the shoulder member 30 and around the joint hole P4 by the members pushed aside.

The first backfilling probe 22 backfills the joint hole P4 with the overlay portion P5.

The first backfilling probe 22 has a substantially columnar shape and is provided, on a front end thereof, with a first backfilling surface 22a (a backfilling surface) formed of a circular flat surface which is orthogonal to the rotation axis 20a and has a diameter larger than the outer diameter of the overlay portion P5 (an inner diameter of the shoulder member 30).

Then, a first backfill protrusion 22b is formed on the center of the first backfilling surface 22a (on the rotation axis 20a).

The first backfill protrusion 22b has a substantially conical shape, and protrudes toward the stacked body PP.

Note that the protrusion dimension of the first backfill protrusion 22b from the first backfilling surface 22a is set to be smaller than the plate-thickness dimension of the upper member P1, and the diameter of the base portion of the first backfill protrusion 22b is set to be smaller than the hole diameter of the joint hole P4.

That is, the shape of the first backfill protrusion 22b is set such that layers of aluminum alloy inside the joint hole P4 after the backfilling have dimensions sufficient to suppress generation of electric corrosion.

The shoulder member 30 has a circular cylindrical shape about the rotation axis 20a as a central axis.

Inside the cylinder of the shoulder member 30, the probe 20 rotates, and advances and retreats.

The shoulder member 30 is disposed to be capable of advancing and retreating relative to the anvil 10 (the stacked body PP) along the rotation axis 20a.

The shoulder member 30 is caused to advance and retreat, and move by a shoulder drive mechanism 44 as a drive source.

The shoulder member 30 is formed of a conductive material.

The drive mechanism 40 includes a rotating drive mechanism 41, an advancing and retreating drive mechanism 42, an anvil drive mechanism 43, and the shoulder drive mechanism 44.

The rotating drive mechanism 41 is a drive source for causing the probe 20 to rotate.

The advancing and retreating drive mechanism 42 is a drive source for causing the probe 20 to advance and retreat.

The anvil drive mechanism 43 is a drive source for causing the anvil 10 to advance and retreat.

The shoulder drive mechanism 44 is a drive source for causing the shoulder member 30 to advance and retreat.

The resistance welder 50 causes current to flow through the stacked body PP by using the semi-spherical portion 12 of the anvil 10 and the shoulder member 30 as electrodes to weld members included in the stacked body PP with each other.

The controller 60 controls the drive mechanism 40 and the resistance welder 50.

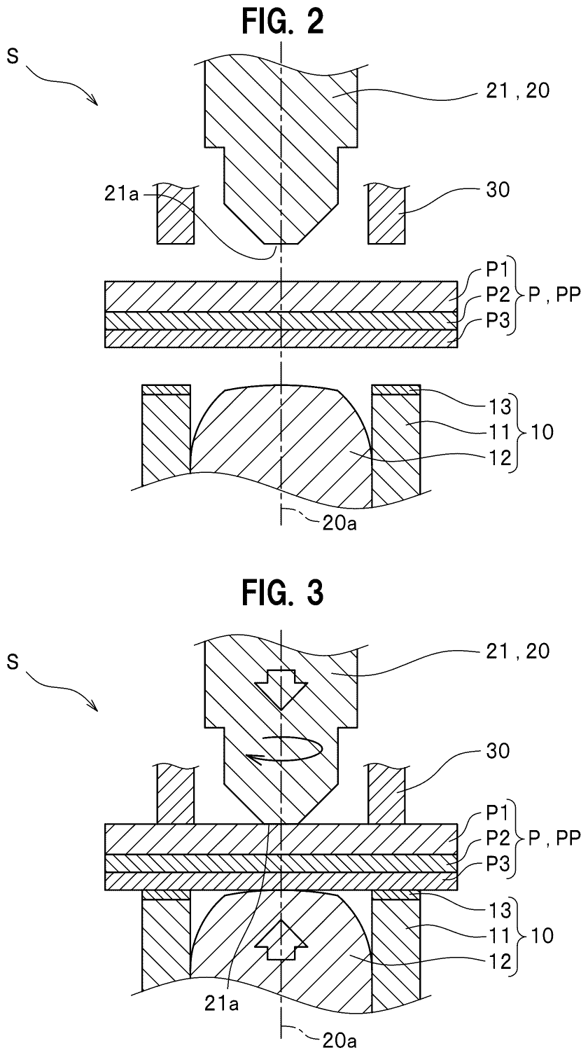

Next, an operation of the friction stir welding apparatus S (joining procedure) will be described (see FIGS. 2-10).

First, a step of causing the anvil 10 to support the stacked body PP is conducted (see FIG. 2).

Note that before this step is conducted, the joining probe 21 is attached to the apparatus body (see FIG. 2).

In the present step, first, the stacked body PP is placed on the anvil 10.

Here, the stacked body PP is disposed such that a portion to be joined is located on the semi-spherical portion 12.

Then, the shoulder member 30 is caused to advance to hold and fix the stacked body PP between the shoulder member 30 and the anvil 10.

Note that although the procedure of moving the stacked body PP in conformity to the position of the friction stir welding apparatus S has been described above, the procedure is not limited to this.

For example, a procedure of moving and changing the position and direction of the friction stir welding apparatus S in conformity to the stacked body PP without moving the stacked body PP from the original position may be employed.

Next, a step of pressing the joining surface 21a of the joining probe 21 against the stacked body PP, and softening the stacked body PP with frictional heat generated by sliding contact to join the plate members P each other and form an overlay portion P5 is conducted (see FIGS. 3 to 6).

In the present step, the controller 60 activates the drive mechanism 40 to cause the joining probe 21 to rotate and advance toward the stacked body PP (see FIG. 3).

Then, the rotating joining surface 21a is pressed against the stacked body PP to sequentially soften each plate member P with frictional heat generated by sliding contact.

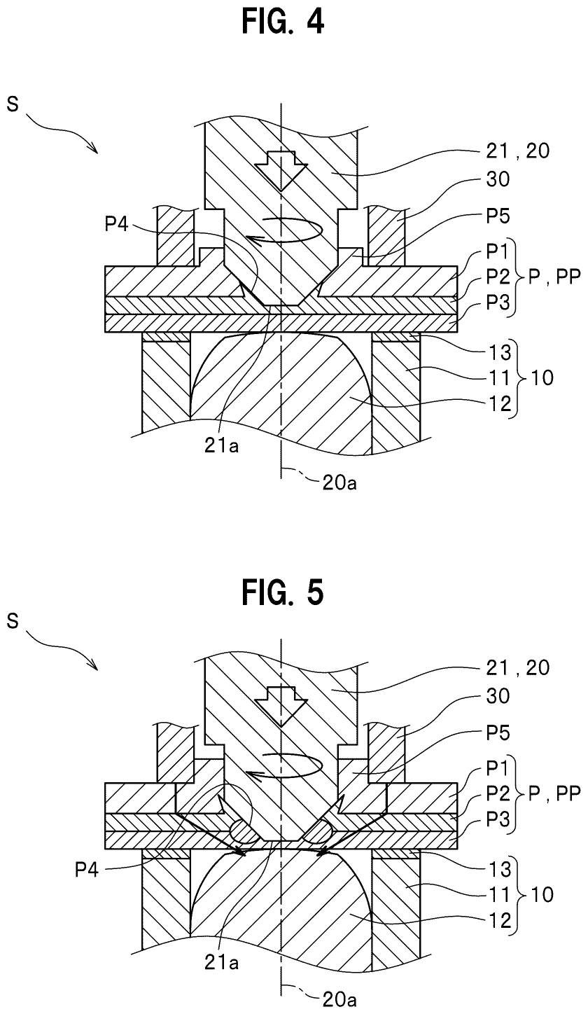

Moreover, the joint hole P4 is formed by causing the joining probe 21 to rotate and advance toward the stacked body PP, so that the joining probe 21 pushes the softened members aside (see FIG. 4).

Then, the overlay portion P5 is formed around the joint hole P4 by the members pushed aside, and the plate members P are joined with each other.

In addition, once the dimension of advancement of the joining probe 21 reaches a set value, the controller 60 activates the resistance welder 50 to weld the middle member P2 and the lower member P3 (see FIG. 5).

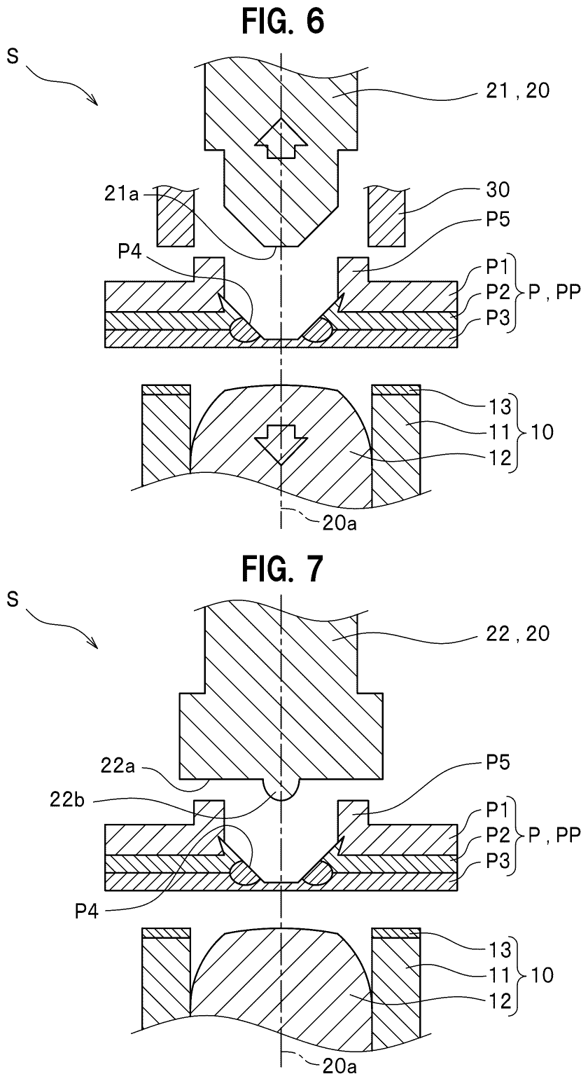

After the welding, the controller 60 stops the resistance welder 50, and causes the joining probe 21 to rotate and retreat, separating the joining probe 21 and the anvil 10 from the stacked body PP (see FIG. 6).

Note that a hole wall of the joint hole P4 in this state is left exposed as a material adjacent portion having a large potential difference.

Next, a step of replacing the joining probe 21 with the first backfilling probe 22 is conducted (see FIG. 7).

In the present step, the probe 20 is replaced by detaching the joining probe 21 from the apparatus body (not shown) of the friction stir welding apparatus S, and attaching the first backfilling probe 22 instead.

Note that the shoulder member 30 may be moved to a position which does not interfere with the first backfilling probe 22.

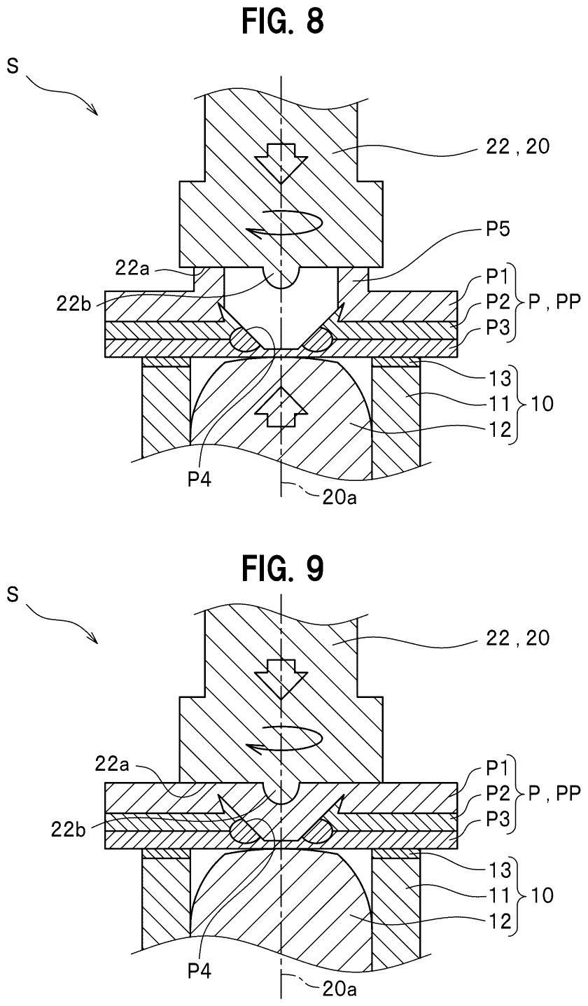

Next, a step of pressing the first backfilling surface 22a of the first backfilling probe 22 against the overlay portion P5, softening the overlay portion P5 with frictional heat generated by sliding contact, and backfilling the joint hole P4 with the softened overlay portion P5 by using the first backfilling surface 22a is conducted (see FIGS. 8 to 10).

In the present step, the first backfilling probe 22 is caused to rotate and advance toward the overlay portion P5 (the stacked body PP) (see FIG. 8).

The first backfilling surface 22a being rotated is pressed against the overlay portion P5 to soften the overlay portion P5 with frictional heat generated by sliding contact.

The first backfilling surface 22a is caused to further advance to backfill the joint hole P4 with the softened portion of the overlay portion P5 (see FIG. 9).

Then, as the joint hole P4 is backfilled, the material adjacent portion of the exposed hole wall is covered up.

Once the dimension of advancement of the first backfilling probe 22 reaches a set value, the controller 60 causes the joining probe 21 to rotate and retreat, separating the first backfilling probe 22 and the anvil 10 from the stacked body PP (see FIG. 6).

The joining step in one joining portion is completed in the above-described manner, and then the joining step in the next joining portion is executed.

Next, advantageous effects of the present embodiment will be described.

By using the friction stir welding apparatus S of the present embodiment, the joint hole P4 which is generated at the time of joining can be backfilled in the joining step.

Then, since the material adjacent portion having a large potential difference can be covered up without being exposed on the surface, the surface of the materials can be protected from electric corrosion.

This eliminates the need of newly providing a step of applying a waterproof sealer to the joining surface for preventing electric corrosion.

In addition, backfilling the joint hole P4 increases the broken area, the joint strength between the lower member P3 and the middle member P2 can be improved.

According to the friction stir welding apparatus S and the friction stir welding method of the present embodiment, it is possible to conduct friction stir welding which can suppress the generation of electric corrosion in a joining step without newly providing a step of applying a waterproof sealer to a material adjacent portion.

In addition, in the friction stir welding apparatus S of the present embodiment, the first backfill protrusion 22b is provided on the center of the first backfilling surface 22a of the first backfilling probe 22.

When the joint hole P4 is backfilled with the overlay portion P5, the joint hole P4 is backfilled gradually from the outer peripheral side of the hole.

However, because no friction is generated between the softened members and the first backfilling surface 22a, there is a possibility that the softened members are cooled and hardened during moving to the central side of the hole, causing a filling failure.

In view of this, the friction surface near the center is increased by providing the first backfill protrusion 22b.

With this, the first backfill protrusion 22b can come into sliding contact with members which are hardened in the course of moving from the outer peripheral side to the central side of the hole, and re-soften the members being hardened, so that the portion around the center can be surely backfilled.

Note that in the friction stir welding apparatus S of the present embodiment, the joining probe 21 and the first backfilling probe 22 are attached to and detached from the apparatus body for replacement; however, the configuration is not limited to this design.

For example, the joining probe 21 and the first backfilling probe 22 may be arranged adjacent to the apparatus body, enabling the probe 20 to perform lateral or rotational movements during joining and backfilling.

That is, the joining probe 21 and the first backfilling probe 22 can be replaced without removing them from the apparatus body. The same advantageous effects as described above can be obtained by this configuration.

When a plurality of joining portions are set on the stacked body PP, a procedure can be used where all the joining portions are first joined using the joining probe 21. Then, the probe 20 is replaced with the first backfilling probe 22, and all the joint holes P4 are backfilled.

This can reduce the time taken for the replacement of the probe, and the working time taken for joining and backfilling can thus be shortened.

Moreover, a unit (a joining unit) consisting of the joining probe 21 and the anvil 10 and a unit (a backfilling unit) consisting of the first backfilling probe 22 and the anvil 10 can be configured separately in a single friction stir welding apparatus S.

Then, by arranging these units adjacent to each other and replacing the probe 20 through unit replacement, the same advantageous effects as described above can be obtained.

In addition, in the case where such a configuration is employed, while backfilling is conducted by the backfilling unit, joining of another portion can be simultaneously conducted by the joining unit.

Hence, such a configuration is more favorable because the working time can be shortened in the case where a plurality of portions have to be joined.

According to the friction stir welding apparatus S of the present embodiment, the stacked body PP is stacked one on top of another, and the probe 20 joins or backfills the stacked body PP from above while the anvil 10 supports the stacked body PP from below. However, the friction stir welding apparatus S is not limited to this configuration.

For example, the stacked body PP may be stacked in a lateral direction, and the probe 20 may join or backfill the stacked body PP from the left side while the anvil 10 supports the stacked body PP from the right side.

This means that joining and backfilling can be conducted regardless of the direction in which plate members are stacked.

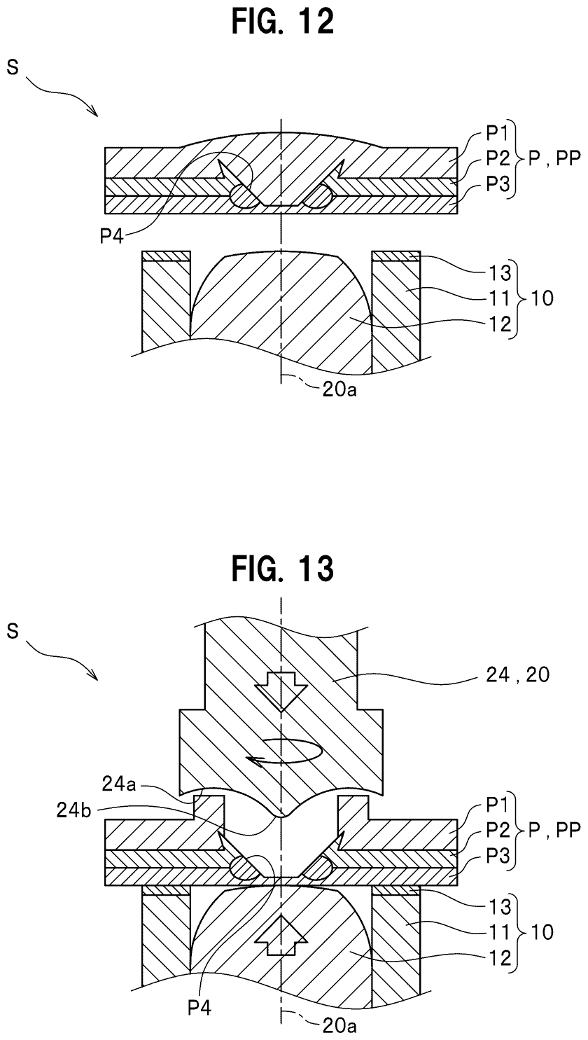

Next, a first modification of the backfilling probe will be described in detail with reference to FIGS. 11 and 12.

Note that in the description, the same elements as in the aforementioned embodiment are denoted by the same reference signs, and repetitive descriptions will be omitted.

In a second backfilling probe 23 of this modification, the shape of a second backfilling surface 23a is different from that of the first backfilling surface 22a of the aforementioned embodiment.

The second backfilling surface 23a of the second backfilling probe 23 of the present modification has a circular shape which is formed about a rotation axis 20a such that an outer peripheral edge of the circular shape is located outside an outer peripheral edge of an overlay portion P5.

In addition, the second backfilling surface 23a has a concave surface shape formed of a curved surface which is depressed such that a center portion of the second backfilling surface 23a is farthest away from a plate surface of a stacked body PP.

That is, the outer peripheral edge of the second backfilling surface 23a is provided at a position farther away from the rotation axis 20a than an inner periphery of a shoulder member 30 is.

In addition, the second backfilling surface 23a has a concave surface shape which is depressed rearward in the advancing direction.

By using the second backfilling probe 23 of the present modification to backfill a joint hole P4, softened members are pressed from the outer peripheral side of the second backfilling surface 23a toward the central side thereof.

This inhibits flowing out of the softened members to the outer side of the second backfilling surface 23a, and thus makes it possible to more surely backfill the joint hole P4.

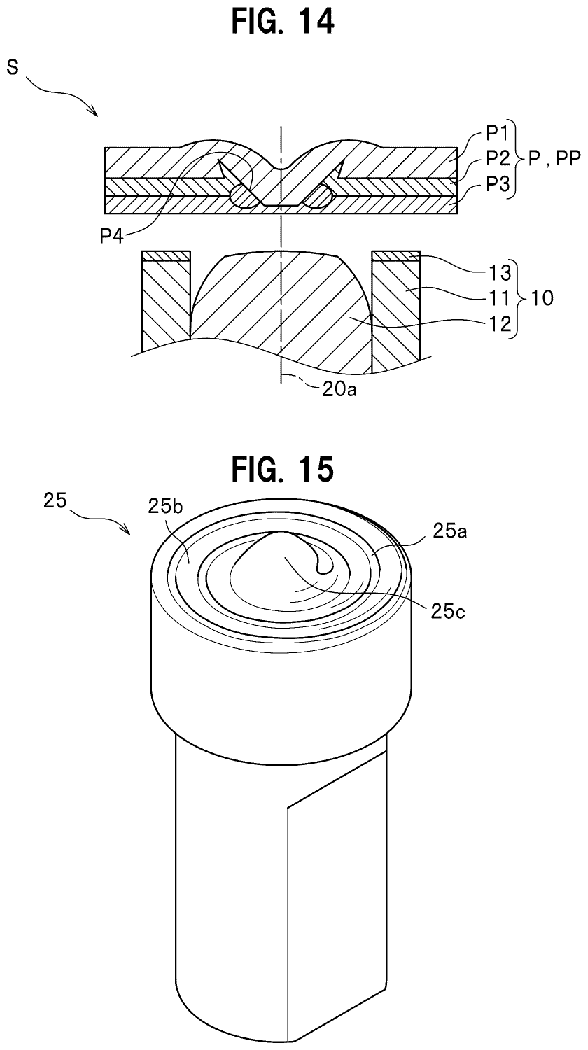

Next, a second modification of the backfilling probe will be described in detail with reference to FIGS. 13 and 14.

Note that in the description, the same elements as in the aforementioned embodiment are denoted by the same reference signs, and repetitive descriptions will be omitted.

In a third backfilling probe 24 of this modification, the shape of a third backfilling surface 24a is different from that of the first backfilling surface 22a of the aforementioned embodiment.

The third backfilling surface 24a of the third backfilling probe 24 of the present modification has a shape in which the first backfill protrusion 22b of the first backfilling probe 22 of the above embodiment and the second backfilling surface 23a of the second backfilling probe 23 of the first modification are combined.

That is, a third backfill protrusion 24b having a substantially conical shape is provided on the center of a concave surface shape.

With such a configuration, softened members can be moved from the outer peripheral side to the central side with the concave surface shape portion, and the third backfill protrusion 24b can come into sliding contact with the members which are cooled and hardened in the course of moving to the central side to re-soften the members.

This makes it possible to more surely backfill the center portion of the joint hole P4.

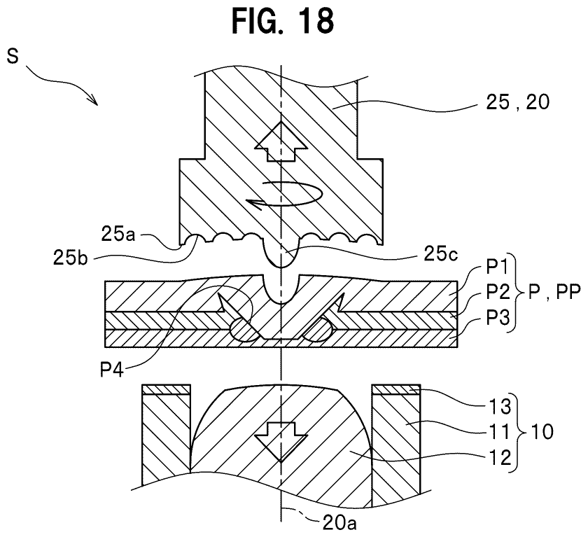

Next, a third modification of the backfilling probe will be described in detail with reference to FIGS. 15 to 18.

Note that in the description, the same elements as in the aforementioned embodiment are denoted by the same reference signs, and repetitive descriptions will be omitted.

In a fourth backfilling probe 25 of this modification, the shape of a fourth backfilling surface 25a is different from that of the first backfilling surface 22a of the aforementioned embodiment.

The fourth backfilling surface 25a of the fourth backfilling probe 25 of the present modification has a circular shape which is formed about a rotation axis 20a such that an outer peripheral edge of the circular shape is located outside an outer peripheral edge of an overlay portion P5.

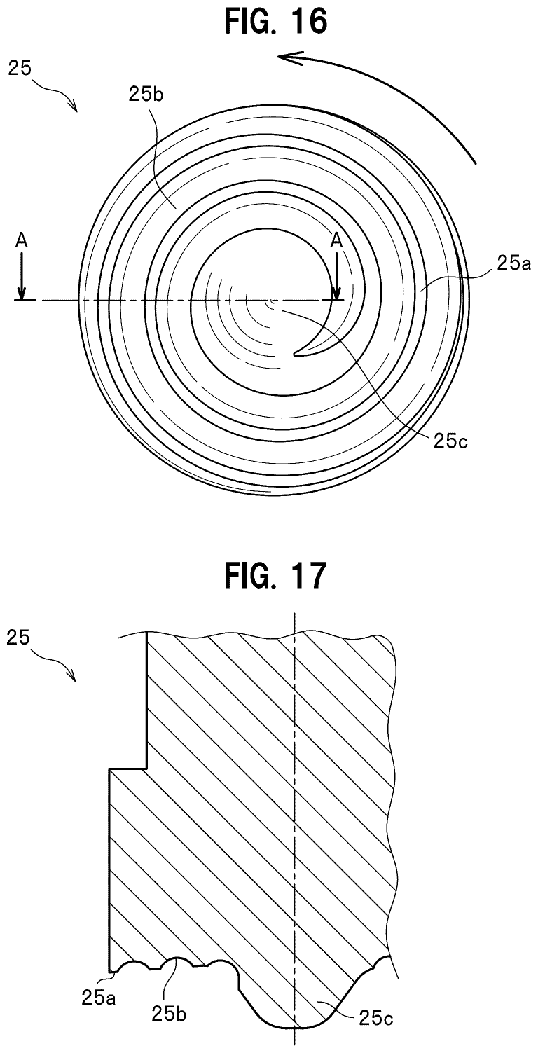

In addition, in the fourth backfilling surface 25a, a groove which has a spiral shape continuing from the outer peripheral edge to the center (a spiral groove 25b) is formed (see FIG. 16).

Moreover, in the center of the fourth backfilling surface 25a, a fourth backfill protrusion 25c which is similar to the first backfill protrusion 22b of the above embodiment is provided.

Then, an end portion of the spiral groove on the central side is connected to the fourth backfill protrusion 25c.

Hence, by rotating the fourth backfilling probe 25 in a counterclockwise direction in FIG. 16, action of collecting softened members toward the fourth backfill protrusion 25c is generated.

Then, the fourth backfill protrusion 25c can come into sliding contact with the members which are cooled and hardened in the course of moving to the central side of the spiral groove 25b to re-soften the members.

By using the fourth backfilling probe 25 of the present modification to backfill a joint hole P4, softened members are moved in the groove of the spiral groove 25b and pressed from the outer peripheral side of fourth backfilling surface 25a to the central side thereof.

This inhibits flowing out of the softened members to the outer side of the fourth backfilling surface 25a, and thus makes it possible to more surely backfill the joint hole P4.

What is claimed is:

1. A friction stir welding apparatus comprising:
an anvil which supports a stacked body including stacked plate members;
a probe which is disposed to face the anvil, and is disposed to be capable of advancing and retreating relative to the stacked body and capable of rotating about a rotation axis along an advancing and retreating direction; and
a shoulder member which has a cylindrical shape through which the probe is capable of being inserted, and holds the stacked body between the shoulder member and the anvil, wherein
the probe includes:
a joining probe which advances toward the plate members, forms a joint hole in the plate members softened by frictional heat generated by a joining surface of the joining probe coming into sliding contact with the plate members and joins the plate members, and forms an overlay portion protruding in a bank shape from a plate surface around the joint hole along an inner peripheral surface of the shoulder member; and
a backfilling probe which advances toward the plate members, and backfills the joint hole with the overlay portion softened by frictional heat generated by a backfilling surface of the backfilling probe coming into sliding contact with the overlay portion, and
the joining probe and the backfilling probe are disposed to be replaceable with each other.

2. The friction stir welding apparatus according to claim 1, wherein
the backfilling probe is disposed to be rotatable about a rotation axis along the advancing and retreating direction, and
the backfilling surface has a circular shape about the rotation axis, and includes a backfill protrusion which protrudes toward the stacked body in a center of the backfilling surface.

3. The friction stir welding apparatus according to claim 1, wherein
the backfilling probe is disposed to be rotatable about a rotation axis along the advancing and retreating direction, and
the backfilling surface has a circular shape which is formed about the rotation axis such that an outer peripheral edge of the circular shape is located outside an outer peripheral edge of the overlay portion, and has a concave surface shape which is formed of a curved surface which is depressed such that a center portion of the concave surface shape is farthest away from a plate surface of the stacked body.

4. The friction stir welding apparatus according to claim 1, wherein
the backfilling probe is disposed to be rotatable about a rotation axis along the advancing and retreating direction, and
the backfilling surface has a circular shape which is formed about the rotation axis such that an outer peripheral edge of the circular shape is located outside an outer peripheral edge of the overlay portion, and has a spiral groove which has a spiral shape continuing from the outer peripheral edge of the circular shape to the rotation axis.

5. A friction stir welding method comprising the steps of:
causing an anvil to support a stacked body;
pressing a joining surface of a joining probe against the stacked body, softening the stacked body with frictional heat generated by sliding contact to join plate members each other and form a joint hole therein and to form an overlay portion;
replacing the joining probe with a backfilling probe; and
pressing a backfilling surface of the backfilling probe against the overlay portion, softening the overlay portion with frictional heat generated by sliding contact, and backfilling the joint hole with the softened overlay portion by using the backfilling surface.
